(19) United States
(12) Patent Application Publication
(10) Pub. No.: US 2011/0195371 A1
(43) Pub. Date: Aug. 11, 2011

(54) ORTHODONTIC COMPONENT, ESPECIALLY BRACKET

(75) Inventor: Markus Johannes Hirsch, Klagenfurt (AT)

(73) Assignee: PBD, Patent & Business Development AG, Zug (CH)

(21) Appl. No.: 12/737,671

(22) PCT Filed: Aug. 4, 2009
(86) PCT No.: PCT/AT2009/000299

§ 371 Date: Feb. 4, 2011

(30) Foreign Application Priority Data
Aug. 6, 2008 (AT) A 1218/2008

(51) Int. Cl. A61C 7/28

(52) U.S. Cl. 433/10

(57) ABSTRACT

The invention relates to an orthodontic component (1) having a base (2) which comprises a visible surface (3), an interspaced basal surface (4) and lateral faces (5 to 8) extending in between, a receiving groove (11) for receiving a bracing wire (12) being arranged in the base (2). The receiving groove (11) further comprises a holding means (17). A first and a second slot-type recess (22, 23) extend from respective lateral walls (19, 20) of the receiving groove (11) on the base (2), the slot-type recesses extending through the base (2) between respective opposite lateral faces (5 to 8). The holding means (17) is formed by a separate web-type base (37) which extends between the two lateral walls (19, 20) of the receiving groove (11) in a hold position for the bracing wire (12) and which engages in the first and second slot-type recess (22, 23) with respective first and second holding elements (40, 41) are arranged at both end sections (38, 39) of the base (37).

The invention relates to an orthodontic component, especially a bracket, as it is described in claim 1.

An orthodontic fastening device has become known from U.S. Pat. No. 4,551,094 A, comprising a bracket and a holding part that can be coupled with the bracket. The bracket has a base body having a base part that is to be fastened to a tooth. Projecting from the base part, the base body has so-called wings on both sides of a receiving slot that serves for receiving the bracing wire or arch wire. These wings have a slight notch on their outer edge section, in each instance. The holding part is disposed to be continuous in the region of the visible side of the bracket, and encloses or engages behind the wings in the coupled state.

Another orthodontic fastening device comprising a bracket as well as a holding part that can be coupled with it has become known from EP 1 468 657 A2. The bracket has a base body, the base of which is configured for being fastened to a tooth. Furthermore, a groove-type receiving slot is disposed in the base body, which extends into the base body, proceeding from the visible surface. On both sides of the receiving slot, in each instance, two pairs of wings having individual wings are configured, disposed at a distance from one another. For receiving the holding part of the bracket, a receiving region is disposed between the wings, in the transverse direction to the longitudinal expanse of the receiving slot, recessed into the base body. The holding part is inserted into this receiving region between the wings, which part is disposed approximately level with the visible surface of the bracket.

Another orthodontic fastening device comprising a bracket and a locking element has become known from EP 1 813 222 A1. The bracket has a bracket base that can be fastened to a tooth. A bracket body projects away from the bracket base, and has a slot that runs from mesial to distal. Furthermore, two pairs of wings, disposed at a distance from one another, are provided. The locking element comprises a lid that is mounted on the bracket so as to pivot about a pivoting axis oriented parallel to the longitudinal direction of the slot, between an open position in which the slot is exposed, into a closed position in which the slot is covered in the region between the two pairs of wings. In the closed position, the lid is engaged into the bracket body. Furthermore, at least one bearing bore is provided in the bracket, the longitudinal axis of which bore is oriented parallel to the longitudinal axis of the slot. In this bore, a bearing shaft having a round cross-section is mounted so as to rotate, and the lid is held in place on this shaft, in rotatable manner.

Another orthodontic fastening device has furthermore become known from DE 10 2006 003 107 A1 or EP 1 810 640 A1, in which the bracket has a holding part configured in stirrup shape passing through the region of its base part. The ends of the holding part project into the receiving slot from the visible side, as stops.

From WO 2005/044131 A1, an orthodontic component having a base body has become known, in which a groove-type receiving slot for receiving a bracing wire is disposed, proceeding from its visible surface. The receiving slot extends into the base body in the direction of the base surface, proceeding from the visible surface. In the region of the visible surface, the receiving slot has a constriction that is formed by projections. For insertion of the bracing wire into the receiving slot, the two hook parts in the transition region toward the foot part are spread apart, therefore making it possible to insert the bracing wire. In this connection, deformation of the base body of the orthodontic component occurs.

From U.S. Pat. No. 5,174,754 A, another orthodontic component has become known, which comprises a base part or foot part as well as hook parts. The receiving slot for the bracing wire is disposed in the region of the hook parts. Holding arms project in the region of the visible surface, which arms prevent the bracing wire from slipping out of the receiving slot. For inserting the bracing wire, the hook parts are resiliently connected, in each instance, with the wire by means of a recess (20) disposed between them and the base or foot part. During the insertion movement, the two hook parts spring apart, in their totality, and allow insertion of the bracing wire into the receiving slot.

Another orthodontic component has become known from DE 10 2004 016 317 B4. This component comprises a foot part, base parts disposed on it, as well as an insert part inserted between them. The two base parts are connected with the foot part, so as to pivot, by means of providing a slot in the region of the foot part. As a result, bending the bracket open and, connected with this, widening the receiving slot, are facilitated. The base part is produced from a plastic with shape memory. Plastics with shape memory have the property of returning to a predetermined shape from a temporary shape caused by the effect of an external stimulus, such as heat or UV light, for example. In this connection, the base parts can be pre-finished in their open position, in which insertion of the bracing wire is made possible in simple manner. After the bracing wire has been inserted, the base parts are deformed toward one another by means of the effect of the external stimulus, and thus the opening width of the receiving slot is reduced in size again, thereby holding the bracing wire in the receiving slot.

Finally, an orthodontic bracket has become known from DE 196 18 364 A1, which bracket is formed from a foot part and a receiving or guide part that stands on it. In the guide part, a slot for receiving a wire arch is provided. In the upper region of the slot of the receiving and guide part, separate projections are disposed, which consist of a second plastic that differs from the plastic of the bracket. This plastic can be sheared off less easily by the wire arch than a projection that has been injection-molded on, having the same shape but made of the same material as the bracket. The two projections delimit the slot from both sides and project into it, in order to retain the wire arch.

The present invention is based on the task of creating an orthodontic component in which the insertion of the bracing wire into the receiving slot provided for it is easily possible, and nevertheless, a good hold of the bracing wire in the receiving slot is guaranteed.

This task of the invention is accomplished by means of the characteristics of claim 1. The advantage that results from the characteristics of claim 1 lies in that in this way, a compact orthodontic component can be created, in which a secure and, above all, easily releasable holder has been created in the receiving slot, for the bracing wire, in the installed position of the bracket on the tooth. In this connection, it is possible, depending on the embodiment of the holding means, which is configured as a slide, to achieve not only passive but also active ligation of the bracing wire in the receiving slot. Here, passive ligation is understood to mean that the bracing wire can move freely in the receiving slot, and active ligation is understood to mean that a clamping force is applied to the bracing wire, proceeding from the holding means, and therefore the wire is held in place in the receiving slot. Because of the fact that the holding means is formed by a separate component, which can be inserted into the groove-type or slot-type recesses disposed on both sides of the slot-type recess, in the region of the visible surface, in this way a double-shear holder, which is therefore sufficiently stable, is achieved. In this way, not only is a stable termination of the receiving slot for the purpose of use achieved over the entire period of use, in the region of the visible surface, but also, the two hooks or wings configured on both sides of the receiving slot are also mechanically held together by the holding means, in the region of the visible surface. In this way, the strength of the entire orthodontic component can be additionally increased even more. Furthermore, the construction height of the bracket that projects beyond the tooth surface is not increased by the integrated arrangement of the holding means in the receiving slot, and therefore the wearing comfort for the user is significantly improved, despite the ease of operation of the holding means.

Another embodiment according to claim 2 is also advantageous, because in this way, after the holding means is released from its engaged position, not only can it be displaced in the transverse direction relative to the longitudinal expanse of the receiving slot, but also a pivoting movement of the means into the further recess is made possible in the uncoupled position. Release of the holding means takes place by means of uncoupling the second holding element from the second slot-type recess, in that the holding means is pulled out approximately in the vertical direction with regard to the side walls that delimit the receiving slot, thereby displacing the first holding element by the same displacement path, guided in the first slot-type recess. As soon as the second holding element is completely uncoupled, a pivoting movement of the entire holding means about the first holding elements guided in the first slot-type recess can be carried out, because at least the web-type base part of the holding means can be pivoted into the further recess. As a result, the holding means can be used multiple times, and can always remain on the bracket during subsequent checkups and during the adjustment work that must be carried out. As a result, the risk of loss is significantly reduced.

Furthermore, an embodiment according to claim 3 is advantageous, because in this way, guidance that acts in the direction of the longitudinal expanse of the receiving slot can be achieved for the holding means, situated in the pivoted position.

By means of the embodiment according to claim 4, it is possible to achieve sufficient guidance without jamming of the first holding element in the first slot-type recess. Furthermore, in this way, however, the production process of the base body can also be improved or facilitated, and thus can take place using an extrusion process, for example.

According to a different embodiment variant according to claim 5, a precise transverse movement with regard to the longitudinal expanse of the receiving slot is achieved.

A further development according to claim 6 is also advantageous, because in this way, longitudinal locking of the holding means in the use position is achieved for the bracing wire secured in the holding position in the receiving slot, by the holding means.

In the embodiment according to claim 7, it is advantageous that while it is true that locking of the holding means in the longitudinal direction of the slot-type recess is achieved in this way, the holding means, particularly its base part, can, however, be configured with a greater breadth or thickness. As a result, the stability of the entire holding means can be additionally improved even more.

By means of the further development according to claim 8, the result is achieved that even more stable and stronger longitudinal locking of the holding means in the first slot-type recess is achieved.

By means of the embodiment by means of claim 9, the stability of the base body in this region can be increased, and in addition, the risk of undesirable deposits, such as food residues, can be minimized.

An embodiment according to claim 10 is also advantageous, because in this way, a catch or snap connection with the second holding element, which is to be used in it, which connection acts in simple manner, can be created.

According to an embodiment as described in claim 11, transverse movement or transverse adjustment of the holding means with regard to the longitudinal expanse of the receiving slot is made possible for its release from the engaged position out of the second slot-type recess. When the holding element has been removed from the second slot-type recess, a pivoting process can then optionally be carried out to expose the receiving slot, or also, the entire holding means can be pushed out of the first slot-type recess, in the longitudinal direction of same.

In this connection, an embodiment according to claim 12 proves to be advantageous, because in this way, a manipulation possibility for the holding means can be created even without any additional excess length beyond the base body.

According to an advantageous further development according to claim 13, a sufficient hold is achieved for the second holding element in the position in which it is situated in the second slot-type recess, and also, penetration of food residues is prevented.

However, an embodiment according to claim 14 is also advantageous, because in this way, freedom of movement for manipulation for activation of the holding means can be created in this way, with little demand for space.

According to claim 15, the simple folding and pivoting movement of the holding means in connection with the further recess is ensured.

In the embodiment according to claim 16, an engaged position of the holding means in the holding position is achieved for the bracing wire in the first slot-type recess. In this way, it is also possible to do without additional holding or locking means.

In this connection, the embodiment according to claim 17 proves to be advantageous, because in this way, not only can a guided displacement movement of the first holding element of the holding means in the first slot-type recess be carried out, but also, a relative pivoting or rotating movement of the entire holding means about the first holding element is made possible. In this way, a combined pushing and folding movement of the holding means with regard to the base body can be carried out.

In this connection, an embodiment according to claim 18 is also possible, because in this way, a pivoting movement in the receiving plane of the recesses and an attendant undesirable uncoupling of the holding means out of the locked position is prevented.

The embodiment according to claim 19 allows a releasable coupling connection between the second holding element and the second, slot-type recess, in simple manner. In this way, it is possible to make do even without additional locking elements, and therefore the production of the entire orthodontic component is significantly simplified and therefore becomes more cost-advantageous.

An embodiment according to claim 20 or 21 is advantageous, because in this way, secure, releasable engagement or coupling of the second holding element and thus of the entire holding means can be achieved with simple means.

However, an embodiment according to claim 22 is also advantageous, because in this way, the bracing wire still disposed in the receiving slot can be pressed additionally against the base surface of the receiving slot, and therefore even greater forces for the treatment of the incorrect tooth position can be transferred to the tooth, proceeding from the bracing wire.

By means of the embodiment according to claim 23, manipulation of the holding means by the medical personnel can be improved.

An embodiment according to claim 24 is also advantageous, because in this way, the strength of the base part of the holding means can be increased.

However, an embodiment according to claim 25 is also advantageous, because in this way, the uncoupling movement of the holding means out of the second recess can be facilitated.

Finally, however, an embodiment as described in claim 26 is also possible, because in this way, on the one hand, manipulation is facilitated, and on the other hand, the stability of the entire holding means is additionally improved.

The invention will be explained in greater detail in the following, using the exemplary embodiments shown in the drawings.

These show:

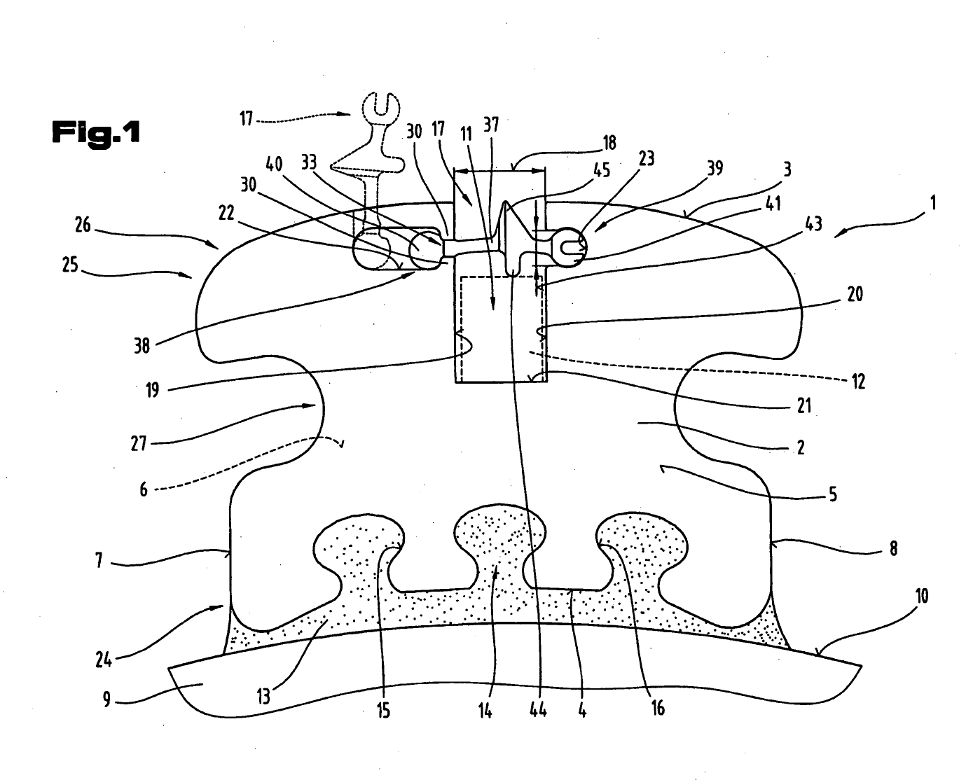

FIG. 1 an orthodontic component configured according to the invention, in a front view and in a simplified schematic representation;

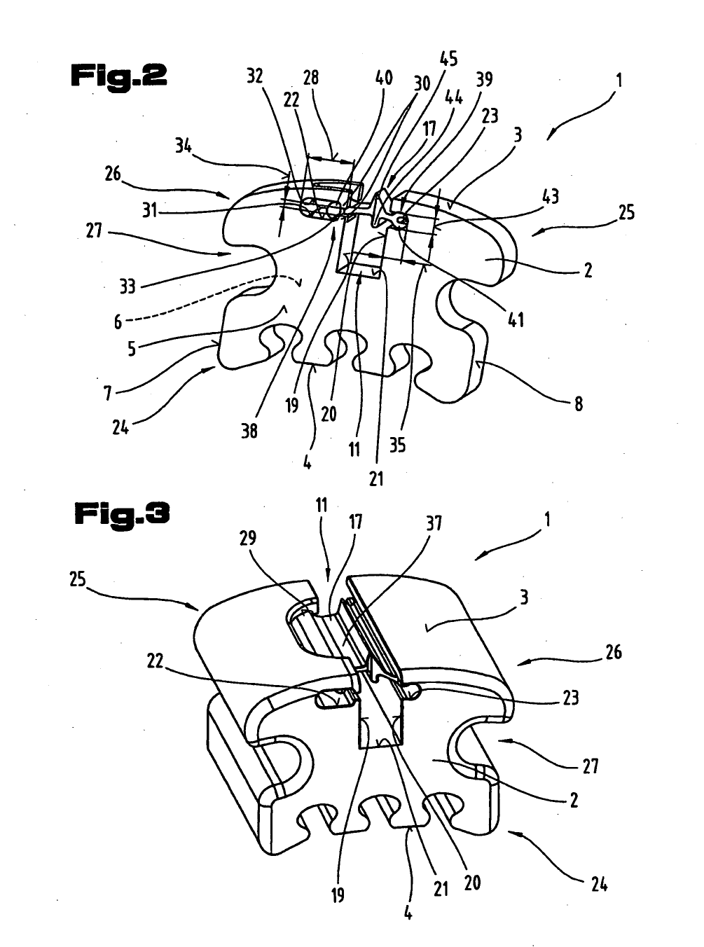

FIG. 2 the orthodontic component according to FIG. 1, in a diagrammatic, simplified representation;

FIG. 3 the orthodontic component according to FIGS. 1 and 2 in a different diagrammatic view and simplified representation;

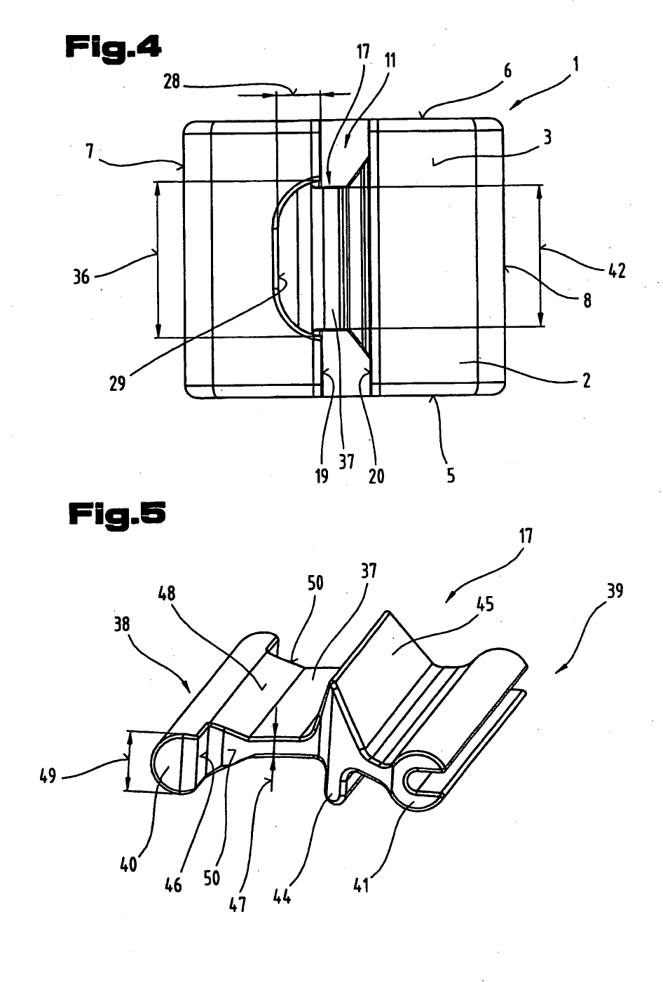

FIG. 4 the orthodontic component according to FIG. 1 to 3, in a top view and simplified representation;

FIG. 5 the holding means of the orthodontic component according to FIG. 1 to 4, in a diagrammatic, simplified representation;

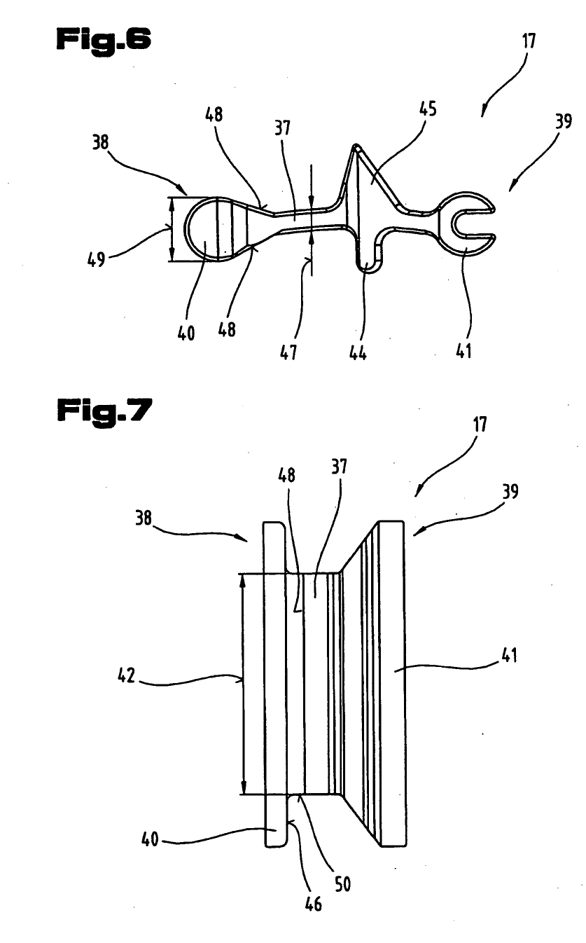

FIG. 6 the holding means according to FIG. 5 in a front view;

FIG. 7 the holding means according to FIGS. 5 and 6 in a top view;

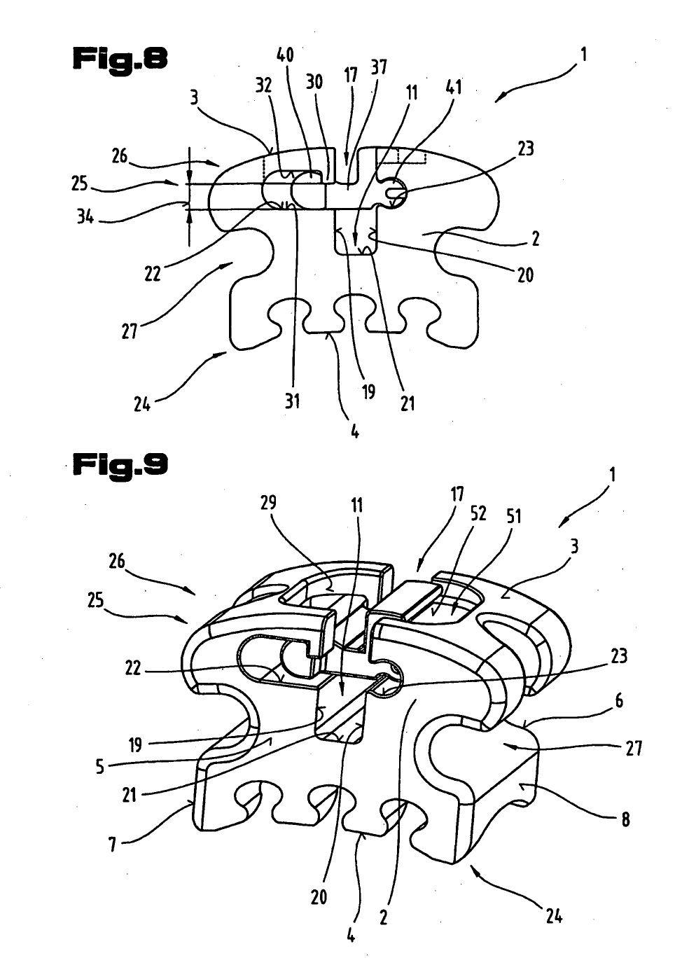

FIG. 8 another orthodontic component configured according to the invention, in a front view and simplified schematic representation;

FIG. 9 the orthodontic component according to FIG. 8, in a diagrammatic, simplified representation;

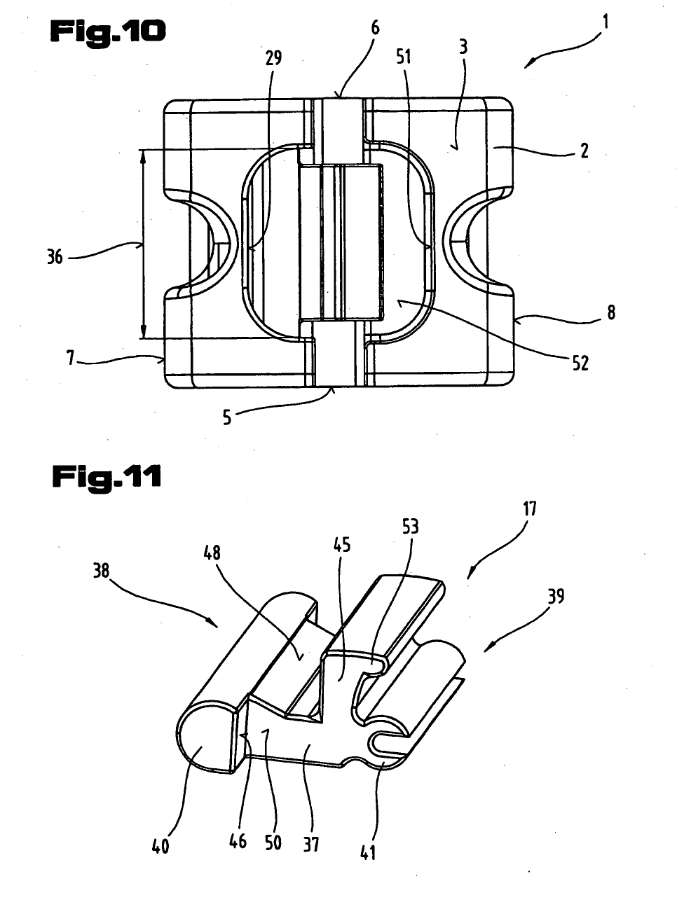

FIG. 10 the orthodontic component according to FIGS. 8 and 9 in a top view and simplified representation;

FIG. 11 the holding means of the orthodontic component according to FIG. 8 to 10 in a diagrammatic, simplified representation;

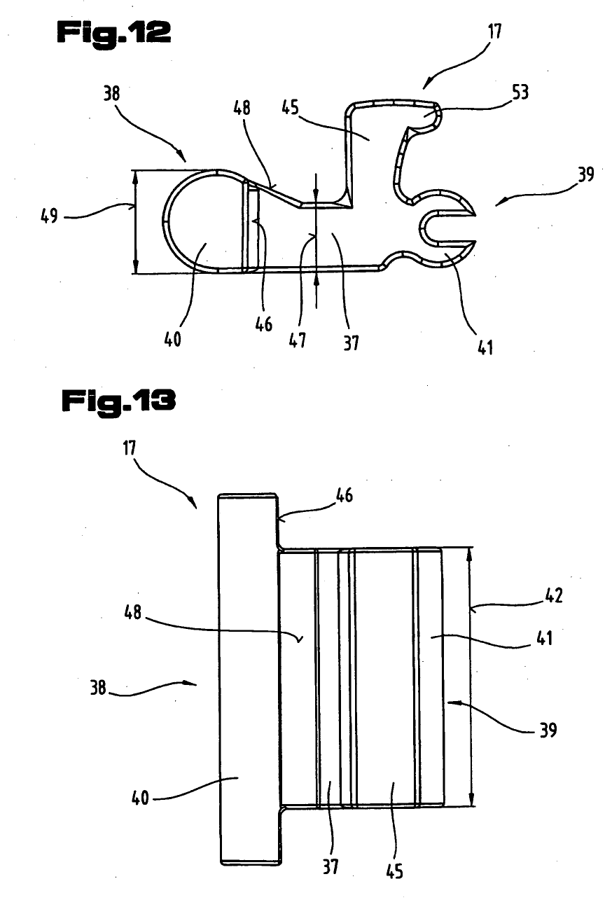

FIG. 12 the holding means according to FIG. 11 in a top view;

FIG. 13 the holding means according to FIGS. 10 and 11 in a top view.

As an introduction, it should be stated that in the different embodiments described, the same parts are provided with the same reference symbols or the same component designations, whereby the disclosures contained in the description as a whole can be transferred analogously to the same parts having the same reference symbols or the same component designations. Also, position information chosen in the description, for example at the top, at the bottom, at the side, etc., refer to the figure directly being described and shown, and must be changed appropriately for a new position if the position is changed. Furthermore, individual characteristics or combinations of characteristics from the different exemplary embodiments that are shown and described can also represent independent inventive solutions or solutions according to the invention, in themselves.

All the information concerning value ranges in the present description must be understood in such a manner that they comprise any desired ranges and all partial ranges within them; for example, the information 1 to 10 is to be understood to mean that all the partial ranges, proceeding from the lower limit 1 up to 10, are included, in other words all partial ranges begin with a lower limit of 1 or more and end at an upper limit of 10 or less, for example 1 to 1.7, or 3.2 to 8.1, or 5.5 to 10.

In FIG. 1 to 7, an orthodontic component 1 is shown in simplified manner, whereby it should be mentioned that the outline shapes or the geometry shown, of the component 1, are shown only as an example, and that this is dependent on the purpose of use or location of use, and must be adapted to that.

The orthodontic component 1 is used in dentistry and usually referred to as a so-called “bracket” there. This serves above all for treatment of tooth malpositions. A bracket is referred to as a self-ligating component 1 if it can hold the bracing wire in the receiving slot independently, without the wire being able to exit from the receiving slot in the vertical direction with reference to its longitudinal expanse. A bracket is referred to as actively ligating if a friction lock is produced between the bracing wire and the bracket, in that pressure is applied to the bracing wire. This has been known for some time, by means of the placement of rubber bands. Finally, passively ligating is understood to mean the interaction of bracing wire and bracket in which the bracing wire is guided in the receiving slot with play. This method is generally selected at the beginning of treatment. Actively self-ligating is understood to mean that the pressure force is exerted on the bracing wire directly by a part of the bracket or by an auxiliary part that interacts with the bracket, such as a rubber ring, for example. In addition, it is also possible, in this connection, to hold the bracing wire, which is disposed in the receiving slot, even more tightly against the component 1, using a rubber-like bracing element, in interaction with the hooks on the component, which can also be referred to as “wings.” In the case of one-sided bracing, rotation of the tooth to be treated can take place, for example.

The orthodontic component 1 comprises a base body 2 that is delimited, in its spatial shape, in simplified manner, by a visible surface 3 that faces the observer, a base surface 4 that faces away from this surface, and side surfaces 5 to 8 that extend between these two surfaces. The base surface 4 serves for affixing the base body 2 to a tooth 9 having a tooth surface 10, which is shown in simplified manner here. Furthermore, a receiving slot 11 for receiving a bracing wire 12 is also shown in the region of the visible surface 3, in simplified manner. Here, the receiving slot 11 extends into the base body 2, proceeding from the visible surface 3, and in the direction of the base surface 4, as well as between the two side surfaces 5, 6 that lie opposite one another.

The base surface 4 of the base body 2 serves for affixing the component 1 to the tooth surface 10 of the tooth 9, by way of connection means 13, such as an adhesive or the like, for example, and for being connected with this surface. Here, the connection means 13 is represented in simplified manner, by means of dots. To increase the size of the connection surface in the region of the base surface 4, at least one, but preferably multiple groove-type recesses 14 can be disposed in the base body 2, recessed into the base surface 4. The recesses 14 extend in the direction toward the visible surface 3, proceeding from the base surface 4. In this exemplary embodiment, the longitudinal expanse of the groove-type recess 14 runs passing between the two side surfaces 5 and 6.

In this exemplary embodiment shown here, the groove-type recess 14 has a cross-section configured approximately in mushroom shape, seen in an axial section. A delimitation line 15 of the groove-type recess 14 is formed exclusively from arc sections 16 disposed one behind the other in the circumference direction, seen in an axial section.

To accommodate the bracing wire 12, the receiving slot 11 is configured in the base body 2, whereby in addition, at least one holding, means 17 is also provided, which is supposed to prevent the bracing wire 12 from unintentionally leaving or slipping out of the receiving slot 11 in the inserted position of the wire in the slot. The receiving slot 11 has a groove width 18, in its cross-section, in other words seen in the direction of its longitudinal expanse, which width is delimited by side walls 19, 20 disposed laterally. A base surface 21 extends between the two side walls 19, 20, on the groove root of the receiving slot 11—in other words on the side facing the base surface 4. Preferably, the two side walls 19, 20 are oriented parallel to one another, whereby the base surface 21 is generally oriented at a right angle with regard to the two side walls 19. 20. The side walls 19, 20 as well as the base surface 21 therefore determine the receiving slot 11 in terms of its cross-sectional shape and size. The cross-section of the bracing wire 12 shown here is selected to be a rectangular cross-section, whereby, however, any other desired cross-sections, such as round, oval, square; polygonal, or the like, for example, can also be used. Depending on the desired application case or treatment procedure, the corresponding bracing wires 12 having the respective cross-sections are then selected.

Proceeding from the two side walls 19, 20 of the receiving slot 11, a first as well as a second recess 22, 23 configured in slot-type manner extend into the base body 2, in each instance, in the direction toward the side surfaces 7, 8, in each instance. In this connection, the two recesses 22, 23 are disposed in the immediate vicinity region with regard to the visible surface 3, and serve to receive the holding means 17.

In the present case here, a rectangular cross-section has been selected and represented as a bracing wire 12. In this connection, the width of the bracing wire 12 approximately corresponds to the groove width 18, whereby it can come about that the wire lies against the two opposite side walls 19, 20 of the receiving slot 11. Here, a height of the bracing wire 12 is selected in such a manner that the bracing wire 12 comes to lie against the base surface 21, on the one hand, and supports itself on the holding means 17, on the other hand. This status is referred to as actively self-ligating and in this connection, a sufficient, optimal force transfer from the bracing wire 12 to the tooth 9 is achieved. In this way, sufficient holding or directing forces can be transferred to the tooth 9. Removal of the bracing wire 12 from the receiving slot 11 can take place by means of so-called unthreading or pulling of the wire in the direction of the longitudinal expanse of the receiving slot 11, or also by means of folding the holding means 17 away, as will still be described in the following. As a result, no deformation movement of the base body 2 is required. After the bracing wire 12 has been removed, the individual teeth 9 can be checked and the same bracing wire 12 can be inserted again for further treatment, or instead, it can also be replaced with a different bracing wire 12, having a different cross-section.

In the case of a bracing wire 12 configured to be round, diameters of 0.014″ [in], 0.016″ [in], or 0.018″ [in] are preferably used. The information with the unit designation or dimensional unit “inch” is selected in “inch [in]” because such bracing wires 12 are used in the USA, and this dimensional unit is considered a standard value there. The bracing wire having the rectangular cross-section can have a dimension of 0.020″ [in] to 0.025″ [in].

In this exemplary embodiment, the base body 2 has a base part or foot part 24 as well as a holding part 25. In this connection, the base part or foot part 24 faces the tooth 9 and thus represents the section of the orthodontic component 1 that is disposed directly adjacent to the tooth 9. The holding part 25 generally comprises a hook part 26, which is disposed or configured on both sides of the receiving slot 11 here. In this connection, the hook part 26 is configured in the region of the visible surface 3. A separate intermediate part 27 is furthermore provided between the hook part 26 and the base part or foot part 24. Viewed in cross-section, the receiving slot 11 is also disposed in the region of the intermediate part 27.

The holding part 25 is configured in one piece with the foot part 24, and additionally represents a preferably bending-rigid cross-section with the foot part 24. Deformation of the intermediate piece 27 for insertion of the bracing wire 12 into the receiving slot 11 is not provided for here.

As was already described above, the two slot-type recesses 22 and 23 are assigned to or interact with the holding means 17 for receiving and holding same on the base body 2, preferably on both sides of the receiving slot 11. The first slot-type recess 22 shown on the left here with regard to the receiving slot 11 extends into the base body 2, particularly the hook part 26, proceeding from the left side wall 19 of the receiving slot 11 here, over a depth 28. Preferably, the first recess 22 passes through the base body 2 analogous to the receiving slot 11, also in the same direction between the two side surfaces 5, 6, which lie opposite one another here. Furthermore, the second slot-type recess 22 preferably also extends continuously between two side surfaces 5 to 8 that lie opposite one another, in each instance—here between the two side surfaces 5 and 6—seen in the longitudinal direction with regard to the receiving slot 11.

In addition, in this exemplary embodiment, a further recess 29 is assigned to the first slot-type recess 22, in the region of the visible surface 3, proceeding from this surface, as well as to the receiving slot 11, which recess extends continuously from the visible surface 3 to the first slot-type recess 22, in the manner of a release, and opens into this recess. This release or recess 29 has a cross-sectional area or spatial shape configured in U shape or C shape, when looking at the visible surface 3, and serves to receive the holding means 17 in the position in which access to the receiving slot 11 is supposed to be made possible. In this connection, a length 36 of the recess 29 in the direction of the longitudinal expanse of the receiving slot 11 is shorter than the entire component 2 in the same direction, between the two opposite side surfaces 5, 6. However, the cross-sectional area or spatial shape of the recess 29, when looking at the visible surface 3, can also be selected to be polygonal, particularly rectangular, with correspondingly configured transition radii between the delimitation edges. Thus, partial sections configured in web-type manner, which belong to the base body 2, remain on both sides of the recess 29. The depth of the recess 29, proceeding from the side wall 19 of the receiving slot 11, can correspond to as much as maximally the depth 28 of the slot-type recess 22.

The first recess 22 is furthermore configured to be decreased or reduced in size, in terms of its clear cross-section, in its end region that faces the receiving slot 11, by means of at least one but preferably multiple web-type projections 30. In this connection, here the projections 30 project in the direction of the delimitation surface 32, 31 that lies opposite, in each instance, or toward one another, proceeding from delimitation surfaces 31, 32 that delimit the recess 22 in terms of its cross-section. Preferably, the two delimitation surfaces 31, 32 are oriented parallel to one another as well as in a vertical direction with regard to the side wall 19, 20 of the receiving slot 11, if applicable.

A gap 33 having a gap width 34 is configured between the projections 30 that face one another, which width is configured to be smaller with regard to a distance between the two delimitation surfaces 31, 32. In this connection, the gap width 34 is measured in the vertical direction with regard to the two delimitation surfaces 31, 32. Seen in the direction of the longitudinal expanse of the slot-type first recess 22 or of the receiving slot 11, the projections 30 preferably extend all the way to the recess 29, in each instance, proceeding from the two side surfaces 5, 6 of the base body 2, which lie opposite one another here, and end at this recess. This also holds true for the two projections 30 disposed on the delimitation surface 31 that lies closer to the base surface 4, as well as on the latter.

The second or the further slot-type recess 23 is configured on the opposite side of the receiving slot 11; this recess extends into the base body 2, with regard to the first slot-type recess 22, over a depth 35 that is less in comparison. In this way, the depth 28 of the first recess 22, with regard to the depth 35 of the second recess 23, can amount to at least twice the depth 35 or also a multiple of it. In order to avoid sharp-edged transitions in the region of the two recesses 22, 23, the transitions are always structured to be rounded, seen in axial section or cross-section, or are basically formed by a rounding.

As can now be seen better when looking at FIG. 5 to 7 together, the holding means 17 is formed by a separate base part 37 configured in web-type manner, which part extends between the two side walls 19, 20 of the receiving slot 11 in a holding position for the bracing wire 12, seen in the longitudinal expanse of the receiving slot 11, as can best be seen in FIG. 1. The base part 37, configured in web-type manner, has first and second holding elements 40, 41 in its two end regions 38, 39. In this connection, a holding position for the bracing wire 12 is understood to be that position of the holding means 17 in which the base part 37 extends over the bracing wire 12, which is disposed in the receiving slot 11, on the side facing away from the base surface 21, and thus extends between the two side walls 19, 20 of the base body 2. The two holding elements 40, 41 disposed or configured on the base part 37 engage into the first and second slot-type recess 22, 23 in the holding position for the bracing wire 12, in each instance, and are preferably releasably held, engaging into at least one of these recesses. This particularly holds true for the second holding element 41 in the second slot-type recess 23.

The web-type base part 37 of the holding means 17 has a length 42 in the direction of the longitudinal expanse of the receiving slot 11, particularly in the region that faces the side wall 19 and thus the first slot-type recess 22, which length is adapted to the length 36 of the further recess 29. Preferably, the length 42 of the base part 37 is structured to be shorter than the length 36 of the further recess 29, in order to allow the holding means 17 to be folded up or pivoted into the further recess 29 in its release position. This folding movement is performed about the first holding element(s) 40 that is/are mounted to be guided in the first slot-type recess, whereby a pivot axis is formed by the holding element 40, which also extends in the longitudinal expanse of the first slot-type recess 22. The pivoted position and thus the release position for the bracing wire 12 are shown with dot-dash lines in FIG. 1.

In order to prevent the holding means 17, particularly the two holding elements 40, 41 from unintentionally being released or slipping out of the two slot-type recesses 22, 23, in the longitudinal expanse of the receiving slot 11, it is advantageous if the web-type base part 37 is supported, in the holding position for the bracing wire 12, on at least one projection 30 that projects into the first slot-type recess 22. For this purpose, the web-type base part 37 must be structured with a corresponding thickness, which is selected to be greater, in this region, than the gap width 34 between the projections 30 that project toward one another.

As was already described above, the projection(s) 30 is/are disposed or provided on at least one delimitation surface 31, 32 that delimits the slot-type first recess 22. The first holding element 40 of the holding means 17 can furthermore be supported in the holding position for the bracing wire 12, on the side facing away from the receiving slot 11, against the projection 30 that projects into the first slot-type recess 22. In this way, an additional contact delimitation for the displacement movement of the holding means 17 is achieved, transverse to the longitudinal expanse of the receiving slot 11.

For releasable holding or coupling of the second holding element 41 in the second slot-type recess 23, it is advantageous if the second holding means 41 has a cross-section configured in C shape, seen in axial section with reference to the longitudinal expanse of the second slot-type recess 23. The cross-section configured in C shape can be produced, for example, in that a groove-type depression is introduced from one side, proceeding from a solid round material. In this connection, the two shanks of the C-shaped cross-section project into the second slot-type recess 23, in the holding position for the bracing wire 12, in the direction facing away from the receiving slot 11. For engaged holding of the second holding element 41 in the second slot-type recess 23, it is furthermore advantageous if the recess 23 has a lesser clear width 43 as compared with the recess 23, seen in its longitudinal expanse and in its end region that faces the receiving slot 11. In this way, it is possible to deform the second holding element 41, with slight deformation of the two shanks of the cross-section configured in C shape, and thereby to push the second holding element 41 into the second slot-type recess 23. This takes place in the transverse direction with regard to the longitudinal expanse of the receiving slot 11. For this purpose, it is advantageous if the material for forming the holding element 41 or also of the entire holding means 17 is configured to be elastically deformable.

In order to achieve a corresponding pressure force from the holding means 17 onto the bracing wire 12, in the direction of the base surface 21 of the receiving slot 11, it is advantageous if a continuation 44 that projects in the direction toward the base surface 21 of the receiving slot 11 is disposed on the base part 37 of the holding means 17, in the holding position for the bracing wire 12. In this way, it is possible to dispose the continuation 44 continuously over the length of the base part 37. Independent of this, however, multiple such continuations 34 could be provided on the side of the base part 37 that faces the base surface 21.

For easier handling and operation of the holding means 17, it is furthermore advantageous if a further continuation 45 that projects to the side that faces away from the base surface 21 of the receiving slot 11 is disposed on the base part 37 of the holding means 17, in the holding position for the bracing wire 12. This further continuation 45 can have a cross-section that is configured to narrow in wedge shape, seen in an axial section with regard to the longitudinal expanse of the receiving slot 11, toward the side that faces away from the base surface 21 of the receiving slot 11. In this way, a pressure force can be exerted on the two wedge surfaces; by means of a dental instrument, in order to thereby pull the holding means 17, with its second holding element 41, out of the second slot-type recess 23, thereby pushing the first holding element 40 into the first slot-type recess 22, which has a greater depth 28. As soon as the second holding element 41 comes out of engagement with the second recess 23, the entire holding means 17 can be pivoted or folded up around the first holding element 40, within the first slot-type recess 22, into the further recess 29. In this way, the cross-section of the receiving slot 11 is released by the holding means 17, all the way to the visible surface 3, and in this way easy manipulation of the bracing wire 12 is made possible.

As was described above, the web-type or web-like base part 37 has the length 42, seen in the direction of the longitudinal expanse of the receiving slot 11, so that it can be received in that region facing the first slot-type recess 22, in the further recess 29 configured there in the visible surface 3. For this purpose, the first holding element 40 disposed in the first end region 38 has a greater longitudinal expanse, as compared with the length 42 of the base part 37, in order to ensure engagement with or contact against the projections 30 described above, which are disposed on the delimitation surface(s) 31, 32. The first holding element 40 has a cylindrical spatial shape on the side facing away from the base part 37, thereby allowing a pivoting or rotational movement of the entire holding means 17 in the first slot-type recess 22. In this way, the first holding element 40 also forms a pivot axis in the form of a peg-shaped continuation. Furthermore, on the side facing the base part 37, the first holding element 40 has one but preferably two contact surfaces 46 disposed on both sides of the base part 37, which surfaces are formed by flattening of the cylindrically configured holding element 40. These surfaces serve for contact against the projection(s) 30, in the installed holding position of the holding means 17 for the bracing wire 12, as has already been described above.

The base part 37 has a thickness 47 in the perpendicular direction relative to its longitudinal expanse. This thickness is selected to be relatively thin, and corresponds to the required strength properties of the holding means 17. Proceeding from the base part 37, a transition region 48 all the way to the first holding element 40 is provided, which region bridges the difference between the thickness 47 of the base part 37 and a breadth 49 of the first holding element 40 in the same direction. In this connection, the breadth 49 is selected in such a manner that it is adapted to the distance between the two delimitation surfaces 31, 32 of the first slot-type recess 22. Seen in the direction of the longitudinal expanse of the base part 37 or of the transition region 48, faces surfaces 50 serve to support the entire holding means 17 on the projection(s) 30, seen in the direction of the longitudinal expanse of the receiving slot 11, as has already been described above.

For better longitudinal guidance and holding of the second holding element 41 in the second slot-type recess 23 provided for this purpose, this element preferably has the same longitudinal expanse as was already described above for the first holding element 40. For this purpose, a wedge-shaped expansion is configured toward the second holding element 41, in a front view of the visible surface 3, proceeding from the web-type base part 37.

In FIG. 8 to 13, another embodiment of the orthodontic component 1 is shown, which can be independent, if necessary, whereby again, the same reference symbols or component designations are used for the same parts, as in the preceding FIG. 1 to 12. In order to avoid unnecessary repetition, reference is made to the detailed description of the preceding FIG. 1 to 12, i.e. this description is pointed out.

Since the base body 2 for forming the orthodontic component 1, with its holding means 17 for the bracing wire 12, disposed and held to be guided in it, is configured in very similar manner to the embodiment in FIG. 1 to 7, only the configurations that differ from this will be discussed in greater detail here, and reference is made to the description in the preceding FIG. 1 to 7 for the other, similar details, i.e. this description is pointed out.

In any case, here, once again, the first and second slot-type recess 22, 23 are provided for receiving the holding means 17, whereby the first recess 22 is delimited, in the vertical direction, with regard to the base surface 21 of the receiving slot 11, by the two delimitation surfaces 31, 32. In the exemplary embodiment shown here, the two projections 30 are provided only in the region of the delimitation surface 32 that lies close to the visible surface 3.

Here, again, the further recess 29 having its length 36, which recess extends all the way to the slot-type, first recess 23, is disposed in the region of the visible surface 3, to receive the web-type base part 37.

In addition, however, it would also be possible here to likewise dispose the projection(s) 30 on the delimitation surface 31 of the first slot-type recess 22, which lies closer to the base surface 21. If only the projection(s) 30 is/are provided on only one of the delimitation surfaces 31, 32, a greater gap width 34 is achieved, and therefore the base part 37 of the holding means 17 can also be configured with a greater thickness 47 adapted to this. As a result, even greater strength values for the entire holding means 17 are achieved in this section.

In the exemplary embodiment shown here, the second slot-type recess 23 has a depression 51 assigned to it, in the base body 2, whereby this depression extends into the base body 2, proceeding from the visible surface 3 as well as from the side wall 20 that delimits the receiving slot 11. A base surface 52 of the depression 51 that faces or lies closer to the second slot-type recess 23 is disposed at a distance from the second slot-type recess 23, in the perpendicular direction with regard to the visible surface 3. This depression 51 in the visible surface 3 can be configured analogous to the further recess 29 described above, in terms of its spatial or cross section shape, but ends before it reaches the second slot-type recess 23. Thus, the depression 51 has a cross-sectional surface that is configured in U or C shape, in a view onto the visible surface 3. The depression 51 serves not only as a receiving space for the continuation 45 on the holding means 17, which will be described further below, but also as a clear space for manipulation, in order to pull the entire holding means 17, with its second holding element 41, out of the second, slot-type recess 23, in the direction of the opposite, first recess 22, by way of the continuation 45, and thus to release the releasable engagement or coupling in this region. After the holding means 17 has been displaced in the parallel direction with regard to the delimitation surfaces 31, 32, into the first slot-type recess 22, and this toward the side surface 7, access to the receiving slot 11 can be exposed by the holding means 17, by means of a folding or pivoting movement. In this way, manipulation of the bracing wire 12 disposed on the receiving slot 11, or insertion of the wire into the receiving slot 11, is possible again.

In FIG. 11 to 13, the holding means 17 that belongs to the base body 2, according to FIG. 8 to 10, is shown by itself. This again also comprises the base part 37 configured in web-like manner, with the holding elements 40, 41 disposed or configured in the end regions 38, 39. The base part 37 has the length 42, seen in the direction of the longitudinal expanse of the receiving slot 11, whereby the first holding element 40 has a greater longitudinal expanse, in comparison with this, in order to ensure engagement with the projection(s) 30 disposed on the delimitation surface 31, 32.

The configuration and spatial shape of the two holding elements 40, 41, in terms of its cross-section, can take place analogous to the embodiment according to FIG. 5 to 7 described above.

In the embodiment shown here, in FIG. 11 to 13, the first holding element 40 has a cross-section dimension that is greater as compared with the second holding element 41. The two holding elements 40, 41 are disposed on the base part 37 in such a manner that they are oriented approximately in the same plane relative to one another, on the side that faces away from the further continuation 45 or the side that faces the base surface 21 of the receiving slot 11. By means of the different cross-section dimensions of the two holding elements 40, 41, the center points of the holding element 40, 41, which are configured to be cylindrical, at least in certain regions, in their outer circumference, are offset relative to one another with regard to the base part 37, in terms of height. Again, the widening transition region 48 is disposed on the side of the holding means 17 that faces the continuation 45, between the base part 37 and the first holding element 40.

In contrast to the continuation 45 described above, which is configured in wedge shape, here the further continuation 45 disposed on the side that faces away from the base surface 21 of the receiving slot 11 has a cross-section configured in L shape, seen in an axial section with regard to the longitudinal expanse of the receiving slot 11. In the installed holding position of the holding means 17 for the bracing wire 12, a shank 53 of the continuation 45 configured in L shape, spaced at a distance from the base part 37 of the holding means 17, projects in the direction of the second, slot-type recess 23 or into the depression 51 formed in the visible surface 3. In the installed position of the holding means 17 for the bracing wire 12, it is possible that the shank 52 also projects into the depression 51. In this way, an overlap of the base body 2 between the second, slot-type recess 23 and the depression 51 is achieved.

The exemplary embodiments show possible embodiment variants of the orthodontic component 1, whereby it should be noted at this point that the invention is not restricted to the specifically represented embodiments of same, but rather, diverse combinations of the individual embodiment variants with one another are possible, and this variation possibility lies within the ability of a person skilled in the art who works in this technical field, on the basis of the teaching for technical action provided by the present invention. Therefore, all possible embodiment variants that can be achieved by means of combinations of individual details of the embodiment variant shown and described are also covered by the scope of protection.

For the sake of good order, it should be pointed out, in conclusion, that for a better understanding of the structure of the orthodontic component 1, this and its integral parts have been shown partly not true to scale and/or enlarged and/or reduced in size.

The task on which the independent inventive solutions are based can be derived from the description.

Above all, the individual embodiments shown in FIG. 1 to 4; 5 to 7; 8 to 10 and 11 to 13 can form the object of independent solutions according to the invention. The tasks and solutions in this regard, according to the invention, can be derived from the detailed descriptions of these figures.

### REFERENCE SYMBOL LIST

1 component
2 base body
3 visible surface
4 base surface
5 side surface
6 side surface
7 side surface
8 side surface
9 tooth
10 tooth surface
11 receiving slot
12 bracing wire
13 connecting means
14 recess
15 delimitation line
16 arc section
17 holding means
18 groove width
19 side wall
20 side wall
21 base surface
22 recess
23 recess
24 foot part
25 holding part
26 hook part
27 intermediate part
28 depth
29 recess
30 projection
31 delimitation surface
32 delimitation surface
33 gap
34 gap width
35 depth
36 length
37 base part
38 end region
39 end region
40 holding element
41 holding element
42 length
43 clear width
44 continuation
45 continuation
46 contact surface
47 thickness
48 transition region
49 breadth
50 face surface
51 depression
52 base surface
53 shank
54
55

1. Orthodontic component (1), especially bracket, having a base body (2), which has a visible surface (3), a base surface (4) spaced apart from it, and side surfaces (5 to 8) that extend between these two surfaces, whereby a groove-type receiving slot (11) for receiving a bracing wire (12) is disposed in the base body (2), and the receiving slot (11) extends into the base body (2), proceeding from the visible surface (3), in the direction of the base surface (4), as well as between two side surfaces (5 to 8), whereby the receiving slot (11) is delimited, in terms of its cross-section, by side walls (19, 20) as well as a base surface (21), and having a holding means (17) for the bracing wire (12), disposed in the receiving slot (11), wherein a first as well as a second slot-type recess (22, 23) are disposed in the base body (2), proceeding from the two side walls (19, 20) of the receiving slot (11), in each instance, which recesses extend in the same direction with regard to the receiving slot (11), and pass through the base body (2) between side surfaces (5 to 8) that lie opposite one another, in each instance, and wherein the holding means (17) is formed by a separate base part (37) configured in web-type manner, which part extends between the two side walls (19, 20) of the receiving slot (11) in a holding position for the bracing wire (12), seen in the longitudinal expanse of the receiving slot (11), and engages into the first as well as the second slot-type recess (22, 23) with first and second holding elements (40, 41) disposed in the two end regions (38, 39) of the base part (37).

2. Orthodontic component (1) according to claim 1, wherein a further recess (29) is assigned to the first slot-type recess (22), proceeding from the visible surface (3), as well as to the receiving slot (11), which recess extends continuously from the visible surface (3) to the first slot-type recess (22).

3. Orthodontic component (1) according to claim 2, wherein the further recess (29) has a cross-sectional area configured in U shape or C shape, when looking at the visible surface (3), whereby a length (36) of the recess (29) in the direction of the longitudinal expanse of the receiving slot (11) is shorter than the base body (2) in the same direction.

4. Orthodontic component (1) according to claim 1, wherein the first slot-type recess (22), seen in its longitudinal expanse, is delimited by delimitation surfaces (31, 32) that are disposed to lie opposite one another and are preferably oriented parallel to one another.

5. Orthodontic component (1) according to claim 4, wherein the delimitation surface (31, 32) is oriented in a perpendicular direction with regard to the side wall (19, 20) of the receiving slot (11).

6. Orthodontic component (1) according to claim 1, wherein at least one projection (30) configured in web-type manner is disposed in the first slot-type recess (22), on one of the delimitation surfaces (31, 32), as well as in its end region that faces the receiving slot (11), whereby this projection projects in the direction toward the opposite delimitation surface (32, 31).

7. Orthodontic component (1) according to claim 6, wherein the projection (30) configured in web-like manner is disposed on the delimitation surface (32) that lies closer to the visible surface (3).

8. Orthodontic component (1) according to claim 6, wherein the projection (30) configured in web-like manner is disposed, in each instance, on delimitation surfaces (31, 32) that lie opposite one another and delimit the first slot-type recess (22).

9. Orthodontic component (1) according to claim 6, wherein the projection (30) configured in web-type manner extends all the way to the further recess (29), proceeding from a side surface (5 to 8).

10. Orthodontic component (1) according to claim 1, wherein the second slot-type recess (23), seen in its longitudinal expanse and in its end region that faces the receiving slot (11), has a clear width (43) that is less in comparison with the recess (23).

11. Orthodontic component (1) according to claim 1, wherein the first and the second slot-type recess (22, 23), proceeding from the side wall (19, 20) that delimits the receiving slot (11), in each instance, extend into the base body (2) over a depth (28, 35), whereby the depth (28) of the first slot-type recess (22) is selected to be greater, with regard to the depth (35) of the second slot-type recess (23), particularly at least twice as great, as the second slot-type recess (23).

12. Orthodontic component (1) according to claim 1, wherein in the region of the second slot-type recess (23), a depression (51) is configured in the base body (2), which depression extends into the base body (2), proceeding from the visible surface (3), as well as from the side wall (20) that delimits the receiving slot (11).

13. Orthodontic component (1) according to claim 12, wherein a base surface (52) of the depression (51) is disposed at a distance from the second slot-type recess (23), in the vertical direction with regard to the visible surface (3).

14. Orthodontic component (1) according to claim 12, wherein the depression (51) has a cross-section surface configured in U or C shape in a front view of the visible surface (3)

15. Orthodontic component (1) according to claim 1, wherein the base part (37) of the holding means (17), configured in web-type manner, has a length (42), in the direction of the longitudinal expanse of the receiving slot (11), that is adapted to the length (36) of the further recess (29).

16. Orthodontic component (1) according to claim 1, wherein the holding means (17) is supported, with its web-type base part (37), in the holding position for the bracing wire (12), on the projections (30) that project into the first slot-type recess (22), in the longitudinal direction of the receiving slot (11).

17. Orthodontic component (1) according to claim 1, wherein the holding means (17) is guided so as to pivot with its first holding element (40) that is received in the first slot-type recess (22).

18. Orthodontic component (1) according to claim 1, wherein the first holding element (40) of the holding means (17) is supported on the projection (30) that projects into the first slot-type recess (22), on the side facing away from the receiving slot (11), in the holding position for the bracing wire (12).

19. Orthodontic component (1) according to claim 1, wherein the second holding element (41) of the holding means (17) is held to be releasably engaged in the second slot-type recess (23), in the holding position for the bracing wire (12).

20. Orthodontic component (1) according to claim 1, wherein the second holding element (41) of the holding means (17) has a cross-section configured in C shape, in an axial section with regard to the longitudinal expanse of the second slot-type recess (23).

21. Orthodontic component (1) according to claim 20, wherein the cross-section of the second holding element (41), configured in C shape, is configured to be elastically deformable.

22. Orthodontic component (1) according to claim 1, wherein a continuation (44) that projects in the direction of the base surface (21) of the receiving slot (11) is disposed on the base part (37) of the holding means (17), in the holding position for the bracing wire (12).

23. Orthodontic component (1) according to claim 1, wherein a further continuation (45) that projects toward the side that faces away from the base surface (21) of the receiving slot (11) is disposed on the base part (37) of the holding means (17), in the holding position for the bracing wire (12).

24. Orthodontic component (1) according to claim 23, wherein the further continuation (45) has a cross-section configured to narrow in wedge shape, in an axial section with regard to the longitudinal expanse of the receiving slot (11), on the side that faces away from the base surface (21) of the receiving slot (11).

25. Orthodontic component (1) according to claim 23, wherein the further continuation (45) disposed on the side that faces away from the base surface (21) of the receiving slot (11) has a cross-section configured in L shape, with regard to the longitudinal expanse of the receiving slot (11).

26. Orthodontic component (1) according to claim 25, wherein a shank (53) of the further continuation (45) configured in L shape, spaced at a distance from the base part (37) of the holding means (17), projects in the direction toward the second slot-type recess (23) in the holding position for the bracing wire (12).
